(19) United States
(12) Patent Application Publication
(10) Pub. No.: US 2006/0243940 A1
(43) Pub. Date: Nov. 2, 2006

(54) Hydrophobic properties of tilting valve grommets

(76) Inventor: Aster De Schrijver, London (GB)

Correspondence Address: Armstrong Kratz Quintos;Hanson & Brooks, Suite 220, 502 Washington Avenue, Towson, MD, 21204, US

(21) Appl. No.: 10/550,081

(22) PCT Filed: Mar. 19, 2004
(86) PCT No.: PCT/EP04/02986

§ 371 Date: Sep. 19, 2005

(30) Foreign Application Priority Data
Mar. 20, 2003 (EP) 03075835.3

(51) Int. Cl. F16K 1/16

(52) U.S. Cl. 251/299

(57) ABSTRACT

The invention concerns an improvement to a grommet, preferably for a tilting valve of a container, which increases the protection against moisture diffusion and uptake, in order to avoid blocking or leaking of the valve. The valve comprises a grommet (1) having at least one part made (1A) of non-thermoplastic rubber and another part (1B) made of a thermoplastic material, the latter being in contact with the content of the container. This valve is preferably made by the dual injection technique. The non-thermoplastic rubber may be EPDM or Santoprene and the thermoplastic rubber may be Trefsin.

The present invention concerns an improvement to a grommet for a tilting valve, more particularly regarding the protection against moisture diffusion and uptake.

Generally the tilting valve will be used for dispensing one or two component polyurethane (PU) foam systems contained in a pressurized can or vessel, or any other polymer system curing by moisture/water uptake.

The type of tilting valves relevant for the present invention is used for more than 25 years in order to dispense the content of an aerosol can. By tilting the stem, the valve opens and delivers the vessel's content in a easily controllable way. Such a valve consists of a number of plastic and metal parts. The inner gasket/seal, called the grommet, is made of rubber. Parts are a special metal cup with inlaid rubber gasket, a plastic stems and a grommet made out of rubber.

Since the chemical components present in the can or vessel are water sensitive and react with water to form the final polyurea, it should be acknowledged that any contact with ambient moisture is to be avoided in order to prevent the forming of polyurea-polyurethane and/or similar derivatives inside the can or vessel. Moisture penetrates via the valve system, more particularly the rubber grommet in the case of tilting valves.

The polyurethane formed due to moisture uptake (diffusion) inside the can or vessel sticks against the grommet and or the stem. Once the first layer of PU is formed on the grommet on the face inside the can or vessel, the sealing properties of the valve diminished and makes the valve subject to blocking and/or leaking.

Thus, it is known that water diffusion through the grommet made out of various type of rubber is responsible for the stickiness/blocking of the tilting valve, when moisture reactive products such as OCF, 1 KPU glues or 1 KPU sealants are stored in these type of container. In order to prevent moisture penetration within the prepolymer, a hydrophobic thermoplastic rubber or thermoplastic elastomer could be used. Examples of such elastomers are: styrene-butadiene, butylene-styrene, silicone rubbers, isopropyl ether (Kraton, Shell), chlorinated polyethylene (Tyrin, Dupont de Nemours), epichlorhydrin homopolymers or copolymer, ethylene propylene (Nordel, Dupont de Nemours), fluoroelastomers (Viton, Dupont de Nemours), alcryn MPR (chlorinated olefin interpolymer alloy), Santoprene, and Trefsin (Advanced Elagtomer Services (EXXON).

Although these compounds are hydrophobic, they exhibit other inconveniences such as “creep” which is a well know property of thermoplastic (TP) rubber. Also those rubbers don't have the “snappy properties” needed for such a valve and therefore a metal or plastic spring has been proposed to improve the snappiness of the grommet.

Therefore there is a need for an improved grommet which is still moisture repulsive but keep the required “snappy” properties of rubber and does not required a spring.

According to the present invention, there is a provided a dual plastic grommet with a regular rubber part exhibiting the required snappiness and a thermoplastic part (TP rubber) that will be moisture repellent and therefore will inhibit the water penetration that is causing stickiness and blocage of the valve.

The rubber can be BUNA, EPDM or Neoprene, butyl etc. A particular suitable thermoplastic material is Trefsin from the produced Advanced Elastomer Services.

The grommet is made by the well-known dual injection technique. Adhesion of the two rubbers is then guaranteed.

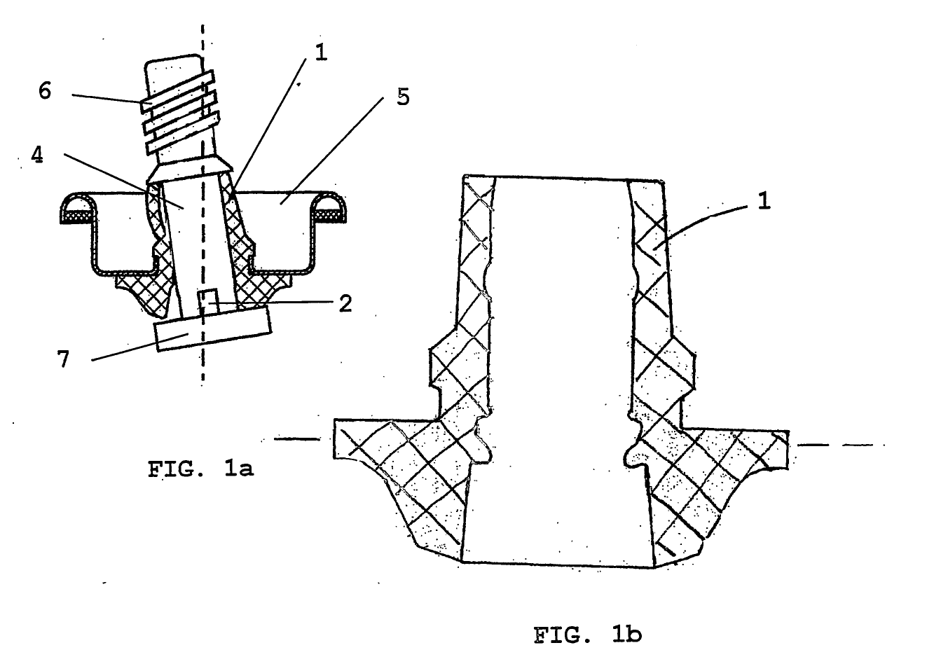

FIG. 1a represents schematically a transversal section of a prior-art valve (FIG. 1a) with a rubber grommet 1 and an enlarged grommet 1 (FIG. 1b), a metal cup 5 and a central stem 4 with an inside channel and a thread 6 at the external end. There are one of several bottom holes 2 in the stem 4 permitting the content of the vessel to be expelled through the inside conduit under pressure when the stem is tilted as illustrated. The tilting operation liberates at least one hole 2 otherwise sealed by the rubber grommet.

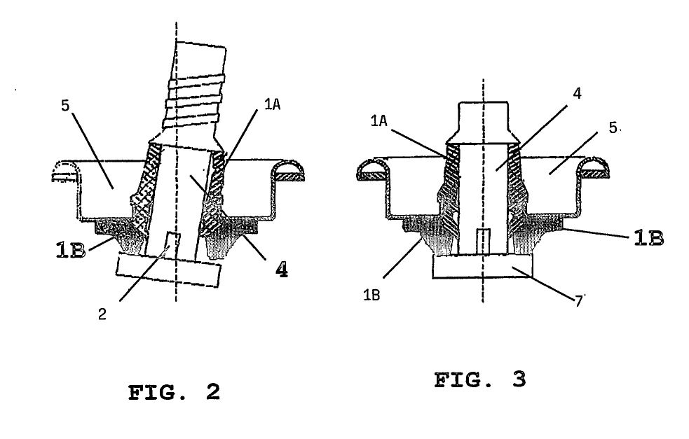

FIG. 2 illustrates an example of the tilting of a valve according to the invention with the grommet 1, the stem 4 and the cup 5, a part 1A made of EPDM or another non thermoplastic rubber and a part 1B made of a thermoplastic rubber such as Trefsin, or any thermoplastic material or copolymers such as polypropylene, polyethylene, various thermoplastic copolymers, etc.

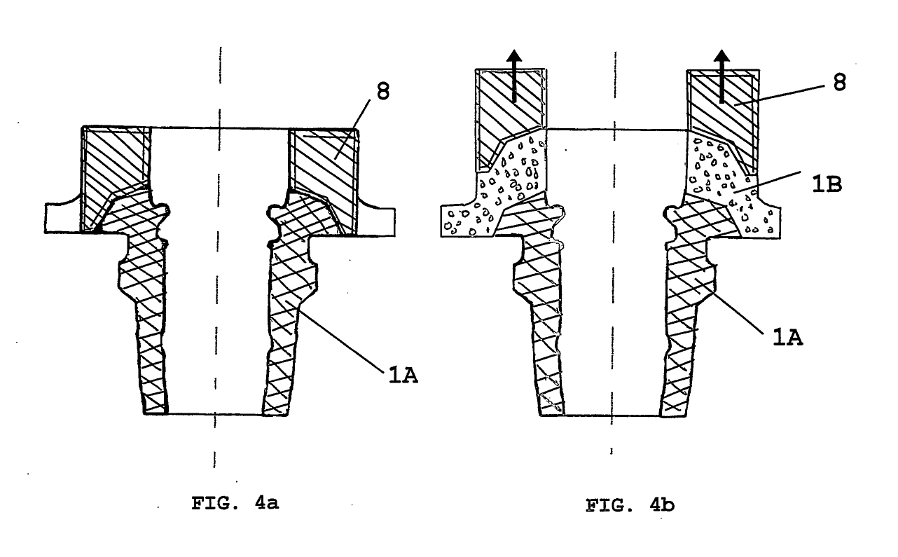

FIG. 4 3 illustrates similarly the invention for another type of valve which is shown in an untilted (closed) configuration.

FIGS. 4a-b illustrate the dual injection technique for obtaining a grommet according to one embodiment of the invention. In step 1 a first material A is injected (TP rubber), then after partial mechanical pull back of the core 8 (mold part), a second rubber B (elastomer such as Trefsin) is injected to provide the complete dual grommet.

The dual injected grommet of the invention may further be treated with a chemical coating or may be coupled to a spring arrangement.

According to the invention, the coating treatment may be conducted either by spraying or directly laying such a coating. For example, preferably just after demoulding the rubber, it can be sprayed by a coating/reactive agent. The rubber can also be brushed, impregnated or plasma treated in order to obtain a coating on the whole surface of the grommet or only on the bottom part (ref. 3 in FIG. 1). The applied composition can be a solution of fluoro-polymer or a silicon based composition.

It has been found that a silicon based composition for coating or impregnation of the ACMOS type is appropriate, for example ACMOS 70-2406. The Münch coating spray MKX 02-125 may also be used. It is postulated that some chemical (covalent) bonding is produced between the coating and the rubber.

After the coating, impregnation or plasma treatment, the grommet is siliconized. This extra post siliconisation improves the snappiness of the rubber and the multi-use properties of the valve. A typical silicone mixture used is Bayer M350.

A significant improvement in overall properties of the valve is noticed. The aerosols or vessels are stored vertically, horizontally and shaken every day, which represent critical situations for a valve. It has however been found that the valves treated according to the invention are still working and no leakage or blocking of the can or vessel is encountered.

1 A valve for a container comprising a grommet having at least one part made of non-thermoplastic rubber and another part made of a thermoplastic material.

2 A valve according to claim 1 wherein the part made of thermoplastic material is located in order to be, at least partly, in contact with the content of the container.

3 A valve according to claim 1 wherein the grommet is made by the dual injection technique.

4 A valve according to claim 1 wherein the non-thermoplastic rubber is EPDM and the thermoplastic rubber is Trefsin or Santoprene.

5 A valve according to claim 1 having furthermore at least one part of the surface of the grommet coated by a polymeric hydrophobic chemical composition.

6 A valve according to claim 5 wherein the composition is a silicon or fluoro-polymer based composition.

7 A valve according to claim 5 wherein the grommet is coated on the bottom surface, oriented inside the container.

8 A valve according to claim 1 wherein the grommet is siliconized.

9 A valve according to claim 1 comprising furthermore a metal or plastic spring pressing upwardly an enlarged base of a stem against said grommet.

10 A valve according to claim 1 which is a tilting valve.

11 A container comprising a valve according to claim 1.

12 (canceled)

13 (canceled)

14 A tilting valve for a container comprising a grommet having at least one part made of non-thermoplastic rubber and another part made of thermoplastic material, the part made of thermoplastic material being located such as to be, at least partly, in contact with the content of the container.

15 A tilting valve according to claim 14 for dispensing a polyurethane foam system contained in a pressurized can or vessel.
